(19) United States
(12) Patent Application Publication
(10) Pub. No.: US 2018/0374005 A1
(43) Pub. Date: Dec. 27, 2018

(54) OPERATING UNIT NUMBER DETERMINATION DEVICE, OPERATING UNIT NUMBER DETERMINING SYSTEM, OPERATING UNIT NUMBER DETERMINATION METHOD, AND RECORDING MEDIUM

(71) Applicant: Panasonic Intellectual Property Management Co., Ltd., Osaka (JP)

(72) Inventor: YOSHIYUKI OKIMOTO, Nara (JP)

(21) Appl. No.: 16/047,002

(22) Filed: Jul. 27, 2018

Related U.S. Application Data
(63) Continuation of application No. PCT/JP2016/004132, filed on Sep. 12, 2016.

(30) Foreign Application Priority Data
Mar. 25, 2016 (JP) 2016-062034

(51) Int. Cl. G06Q 10/04; G06Q 10/06; G06K 9/00; G06T 7/70

(52) U.S. Cl. CPC G06Q 10/04; G06Q 10/0631; G06T 2207/30242; G06K 9/00691; G06T 7/70; G06Q 10/0633

(57) ABSTRACT

An obtaining unit obtains store-visitor number information indicating a store-visitor number, which is a number of customers who visited a store, waiting customer number information indicating a waiting customer number, which is a number of customers waiting to be processed at a plurality of cash registers installed in the store, and influx number information indicating an influx number, which is a number of customers added to the waiting customer number. An influx number prediction unit calculates a predicted influx number, which is a number of customers who are expected to be added to the waiting customer number at the plurality of cash registers after a predetermined time from a current time point, based on the store-visitor number information and the influx number information. A storage unit stores processing capability information indicating a processable quantity that can be processed by each of the plurality of cash registers per a certain time and cost information about an operating cost of each of the plurality of cash registers. A congestion degree prediction unit calculates a plurality of values of a predicted waiting customer number, which is a number of customers who are expected to wait to be processed at the plurality of cash registers after the predetermined time, based on the waiting customer number information, the predicted influx number, and the processing capability information, where each of the plurality of values corresponds to each of a plurality of operating unit numbers of the plurality of cash registers. An operating unit number determination unit calculates an operating unit number of the plurality of cash registers based on the predicted waiting customer number and the cost information.

### TECHNICAL FIELD

The present disclosure relates to an operating unit number determination device that determines an operation unit number of cash registers, an operating unit number determining system including the operating unit number determination device, an operating unit number determination method, and a recording medium.

### BACKGROUND ART

PTL 1 discloses a system in which a number of customers in a predetermined region is measured to predict a number of staff members demanded at checkouts after a predetermined time for the purpose of deploying staff members to the checkouts. This makes it possible to efficiently deploy the staff members, thus improving store productivity and customer satisfaction.

### CITATION LIST

### Patent Literature

PTL 1: Japanese Patent Unexamined Publication (Translation of PCT Application) No. 2008-544379

### SUMMARY

An obtaining unit obtains store-visitor number information indicating a store-visitor number, which is a number of customers who visited a store, waiting customer number information indicating a waiting customer number, which is a number of customers waiting to be processed at a plurality of cash registers installed in the store, and influx number information indicating an influx number, which is a number of customers added to the waiting customer number. An influx number prediction unit calculates a predicted influx number, which is a number of customers who are expected to be added to the waiting customer number at the plurality of cash registers after a predetermined time from a current time point, based on the store-visitor number information and the influx number information. A storage unit stores processing capability information indicating a processable quantity that can be processed by each of the plurality of cash registers per a certain time and cost information about an operating cost of each of the plurality of cash registers. A congestion degree prediction unit calculates a plurality of values of a predicted waiting customer number, which is a number of customers who are expected to wait to be processed at the plurality of cash registers after the predetermined time, based on the waiting customer number information, the predicted influx number, and the processing capability information, where each of the plurality of values corresponds to each of a plurality of operating unit numbers of the plurality of cash registers. An operating unit number determination unit calculates an operating unit number of the plurality of cash registers based on the predicted waiting customer number and the cost information.

### BRIEF DESCRIPTION OF DRAWINGS

FIG. 1 is a block diagram of a cash register operating unit number determining system according to an exemplary embodiment.

FIG. 2 is a flowchart for describing an operation of the cash register operating unit number determining system according to the exemplary embodiment.

FIG. 3 is a diagram for describing prediction of an influx number into cash registers in the operating unit number determining system according to the exemplary embodiment.

FIG. 4 is a table for describing prediction of a degree of congestion in the operating unit number determining system according to the exemplary embodiment.

FIG. 5 is a diagram for describing a comparison between an average wait and an operating cost in the operating unit number determining system according to the exemplary embodiment.

FIG. 6 is a table for describing selection of an operating unit number of cash registers in the operating unit number determining system according to the exemplary embodiment.

### DESCRIPTION OF EMBODIMENT

Hereinafter, an exemplary embodiment will be described in detail with reference to the drawings as appropriate. However, detailed description beyond necessity may be omitted. For example, detailed description of a matter that has been already known well or overlapping description of substantially the same configuration may be omitted. Such omissions are aimed to prevent the following description from being redundant more than necessary, and to help those skilled in the art easily understand the following description. It should be noted that the attached drawings and the following description of the exemplary embodiment are provided for those skilled in the art to fully understand the present disclosure, and the attached drawings and the following description are not intended to limit the subject matter as described in the appended claims.

### Exemplary Embodiment

An operating unit number determination device and an operating unit number determining system including the operating unit number determination device according to the exemplary embodiment determine an operating unit number of cash registers optimal for relieving congestion of the cash registers while keeping a small operating unit number of the cash registers.

### [1. Configuration]

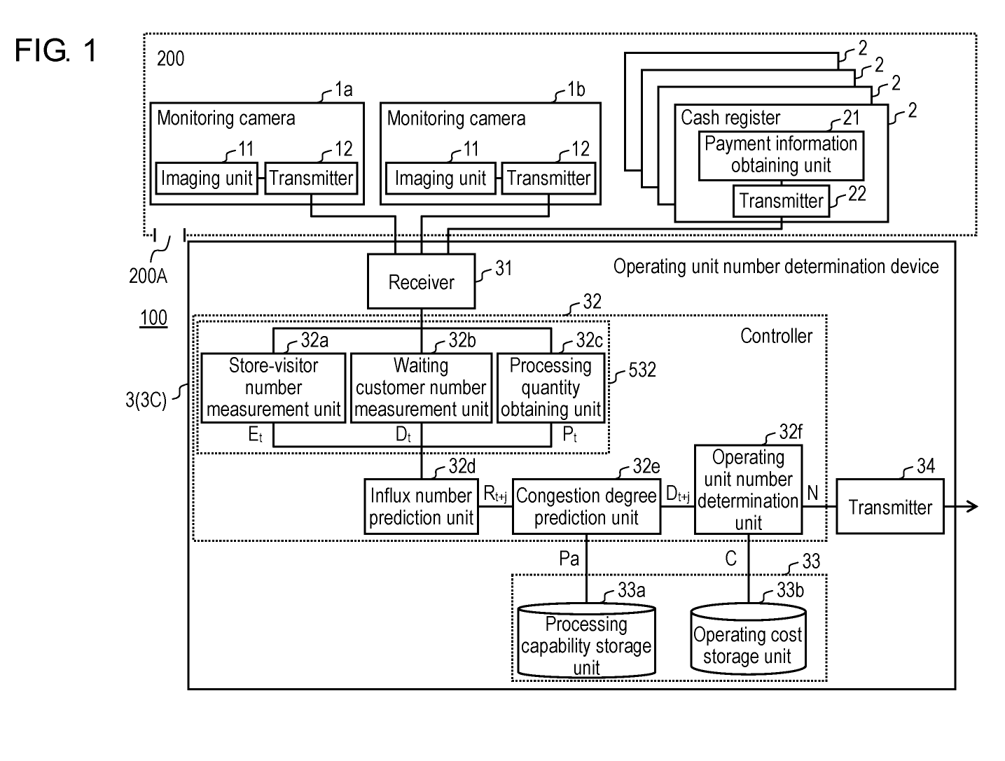

FIG. 1 is a block diagram of operating unit number determining system 100 according to the exemplary embodiment. Operating unit number determining system 100 includes monitoring cameras 1a, 1b installed in store 200, a plurality of cash registers 2 installed in store 200, and operating unit number determination device 3. In the exemplary embodiment, cash register 2 is a POS (Point of Sales) cash register. Operating unit number n of cash registers 2 is a number of operating cash registers 2 among cash registers 2 in store 200. Operating unit number determination device 3 determines optimum operating unit number N of cash registers 2 based on images in store 200 captured by monitoring cameras 1a, 1b and a processing quantity of cash register 2 obtained from cash register 2.

Each of monitoring cameras 1a, 1b includes imaging unit 11 that captures an image and transmitter 12 that transmits the image captured by imaging unit 11. It is possible to achieve imaging unit 11 by a CCD image sensor, a CMOS image sensor, or an NMOS image sensor. Transmitter 12 includes an interface circuit for communicating with external devices based on a predetermined communication standard (for example, LAN or WiFi). Monitoring camera 1a is installed at a position where the image of entrance 200A of store 200 can be captured. Monitoring camera 1b is installed at a position where the image of cash registers 2 of store 200 can be captured.

Cash register 2 includes payment information obtaining unit 21 that obtains payment information and transmitter 22. The payment information indicates that payment for purchase of goods by a customer is completed. Transmitter 22 transmits operation information indicating whether cash register 2 is operating and the obtained payment information. Payment information obtaining unit 21 includes a barcode reader using a scanner, a CCD, a laser, or the like. Transmitter 22 includes an interface circuit for communicating with external devices based on a predetermined communication standard (for example, LAN or WiFi).

Operating unit number determination device 3 includes receiver 31, controller 32, and transmitter 34. Receiver 31 receives images in store 200 from monitoring cameras 1a, 1b and, payment information and operation information from each cash register 2. Controller 32 determines optimum operating unit number N of cash registers 2 based on the received images, the received payment information, and the received operation information. Transmitter 34 outputs operating unit number information indicating determined optimum operating unit number N of cash registers 2. Each of receiver 31 and transmitter 34 includes an interface circuit for communicating with external devices based on a predetermined communication standard (for example, LAN or WiFi).

Operating unit number determination device 3 further includes storage unit 33. Storage unit 33 includes processing capability storage unit 33a and operating cost storage unit 33b. Processing capability storage unit 33a stores processing capability information indicating processable quantity Pa. Operating cost storage unit 33b stores cost information indicating operating cost C of one cash register 2. Processable quantity Pa indicates a number of customers one cash register 2 can settle payment per unit time. Processing capability storage unit 33a and operating cost storage unit 33b can be achieved by a DRAM, a ferroelectric memory, a flash memory, or a magnetic disk, and may be the same or separate storage units.

Controller 32 can be achieved by a semiconductor element or the like. Functions of controller 32 may be configured only by hardware or may be achieved by combining hardware and software. Controller 32 may be configured by, for example, microcomputer, CPU, MPU, DSP, FPGA, or ASIC.

Controller 32 has obtaining unit 532 including store-visitor number measurement unit 32a, waiting customer number measurement unit 32b, and processing quantity obtaining unit 32c. Store-visitor number measurement unit 32a measures store-visitor number Eₜ, which is a number of customers who visited store 200, based on images captured by monitoring camera 1a installed to point at entrance 200A. Waiting customer number measurement unit 32b measures waiting customer number Dₜ, which is a number of customers waiting to be account-processed at cash registers 2, based on images captured by monitoring camera 1b installed to point at cash registers 2. Processing quantity obtaining unit 32c obtains processing quantity Pₜ, which is a number of customers processed by cash registers 2, based on the payment information and the operation information of cash registers 2.

Controller 32 further includes influx number prediction unit 32d, congestion degree prediction unit 32e, and operating unit number determination unit 32f. Influx number prediction unit 32d predicts influx number Rₜ₊ⱼ (predicted influx number) that indicates a number of customers who are expected to go to cash registers 2 and to be added to waiting customer number Dₜ, which is the number of customers waiting to be account-processed at cash registers 2, after predetermined time (j) from current time (t). Congestion degree prediction unit 32e predicts a degree of congestion, which is predicted waiting customer number Dₜ after predetermined time (j), based on predicted influx number Rₜ₊ⱼ and processable quantity Pa. Operating unit number determination unit 32f determines optimum operating unit number N of cash registers 2 based on the predicted degree of congestion and operating cost C.

### [2. Operation]

Operating unit number determination device 3 obtains in advance store-visitor number Eₜ in the past based on images captured by monitoring camera 1a installed to point at entrance 200A, obtains waiting customer number Dₜ in the past based on images captured by monitoring camera 1b installed to point at cash registers 2, and obtains processing quantity Pₜ of cash registers 2 in the past based on payment information and operation information of cash registers 2, thus simulating the degree of congestion of cash registers 2. A method of determining optimum operating unit number N based on a simulation result is described below.

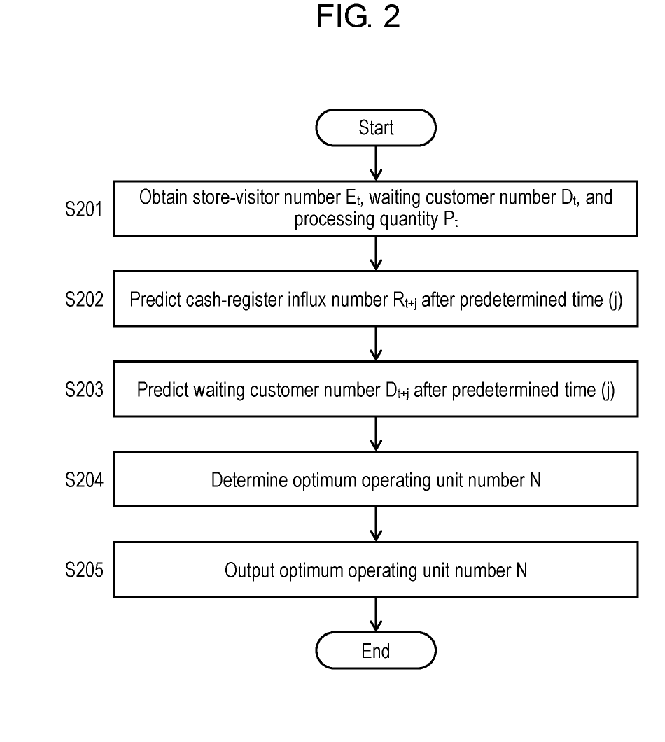

FIG. 2 shows a process of determining optimum operating unit number N, which is performed by controller 32. First, controller 32 obtains store-visitor number Eₜ, waiting customer number Dₜ, and processing quantity Pₜ (step S201). Specifically, store-visitor number measurement unit 32a obtains store-visitor number Eₜ during a predetermined time based on images captured by monitoring camera 1a installed to point at entrance 200A. Waiting customer number measurement unit 32b obtains waiting customer number Dₜ during a predetermined time based on images captured by monitoring camera 1b installed to point at cash registers 2. Processing quantity obtaining unit 32c obtains processing quantity Pₜ of cash registers 2 during a predetermined time based on the payment information and the operation information of cash registers 2.

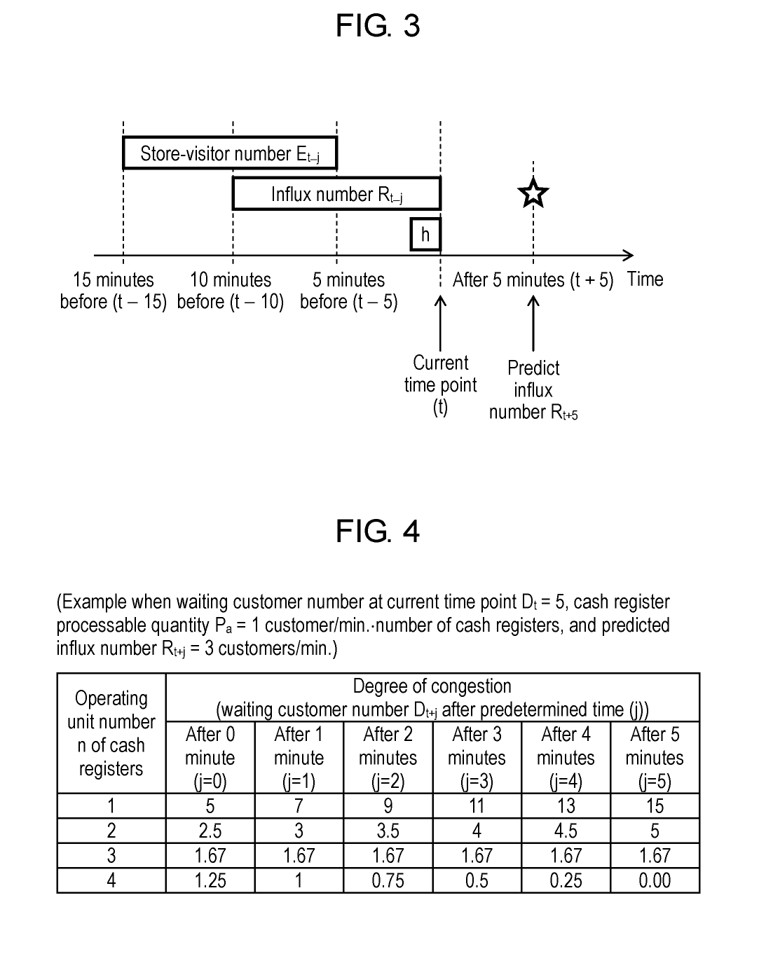

Influx number prediction unit 32d refers to obtained store-visitor number Eₜ to predict influx number Rₜ₊ⱼ after predetermined time (j) (step S202). FIG. 3 shows an example of calculating influx number (predicted influx number) Rₜ₋₅ after a predetermined time (j=5 min.). Influx number Rₜ₊₅ is calculated based on store-visitor number Eₜ₋ᵢ, which is the number of customers who visited a store i minutes prior to current time point (t), that is, 15 minutes to 5 minutes prior to current time point (t) and influx number Rₜ₋ᵢ, which is the number of customers who went to cash registers 2 from a time i minutes before, that is, a time 10 minutes before until current time point (t). Influx number prediction unit 32d calculates influx number Rₜ per unit time after current time point (t) by multiple regression prediction represented by following (Formula 1) that uses coefficients W¹, W², and W³ for weighting, variable h at the current time point, and another variable C. Influx number Rₜ₋ᵢ before current time point (t) and influx number Rₜ₊ⱼ after current time point (t) are a total number of customers who reach all cash registers 2 per unit time.

$${R}_{t + j} = {\sum }_{i = 5}^{15} {W}_{i}^{1} \cdot {E}_{t - i} + {\sum }_{i = 0}^{10} {W}_{i}^{2} \cdot {R}_{t - i} + {W}^{3} \cdot h + C \qquad [ Formula 1 ]$$

Operating unit number determination device 3 obtains in advance store-visitor number Eₜ in the past based on images captured by monitoring camera 1a installed to point at entrance 200A, obtains waiting customer number Dₜ in the past based on images captured by monitoring camera 1b installed to point at cash registers 2, and obtains processing quantity Pₜ of cash registers 2 in the past based on payment information and operation information of cash registers 2, thus simulating the degree of congestion of cash registers 2. Operating unit number determination device 3 thus determines coefficients W¹, W², and W³, and variable h in above (Formula 1) for determining influx number Rₜ₊ⱼ by using past log data to minimize an error between a predicted value and an actually measured value. In addition, a user of operating unit number determination device 3 (for example, a store manager) determines in advance coefficients α, β, and γ for determining optimum operating unit number N of cash registers 2 based on a simulation result of the degree of congestion of cash registers 2. Coefficients W¹, W² may change every unit time (for example, every one minute).

Influx number prediction unit 32d refers to waiting customer number Dₜ and processing quantity Pₜ to calculate influx number Rₜ₋ᵢ during a past predetermined time (i=0 to 10) by following (Formula 2) using waiting customer number Dₜ₋₍ᵢ₋₁₎ (i−1) minutes before, waiting customer number Dₜ₋ᵢ i minutes before, and number Pₜ₋ᵢ of customers whose payment has been completed at all operating cash registers 2 i minutes before.

Rₜ₋ᵢ=Dₜ₋₍ᵢ₋₁₎−Dₜ₋ᵢ+Pₜ₋ₜ [Formula 2]

Waiting customer number Dₜ and processing quantity Pₜ are a total number per a certain time when all cash registers 2 are targets, that is, per unit time. For processing quantity Pₜ, it is possible to use numerical values mechanically counted by using images captured by monitoring cameras installed on cash registers 2. When past influx number Rₜ₋ᵢ is directly measured based on images captured by monitoring cameras or the like, the influx number does not need to be calculated using (Formula 2).

In predicting influx number Rₜ after predetermined time (j), a number of customers in a particular section in store 200, attributes of customers (a gender, an age, and group information (a family, a couple, and the like)), a day of the week, a holiday, a season, and information about events around store 200 may be used as variable C used for prediction. A prediction system is not limited to the multiple regression prediction, and a time series prediction model such as an ARIMA model and an ARCH model may be used. Additionally, prediction may be performed using a state space model such as a Kalman filter or a Particle filter. Deep learning may also be used.

Next, congestion degree prediction unit 32e predicts a value of waiting customer number Dₜ₊ⱼ predicted after a predetermined time (for example, after 0 minute to 5 minutes) for each of a plurality of operating unit numbers of operating cash registers 2 based on a simulation or the like (step S203). FIG. 4 shows a simulated prediction result of predicted waiting customer number Dₜ₋ⱼ based on waiting customer number Dₜ=5, which is the total number of waiting customers at all cash registers 2 at present time point (t) obtained from waiting customer number measurement unit 32b, processable quantity Pa of one cash register 2 per a certain time, that is, per unit time obtained from processing capability storage unit 33a, and influx number Rₜ₊ⱼ per unit time, which is the total number of predicted influx numbers at all cash registers 2 obtained from influx number prediction unit 32d. FIG. 4 shows the simulated prediction result of predicted waiting customer number Dₜ₊ⱼ when processable quantity Pa is 1 customer/min.·number of cash registers and influx number Rₜ₊ⱼ is 3 customers/min. FIG. 4 exemplifies waiting customer number Dₜ₋ⱼ of one cash register 2. Processable quantity Pa is an average value of numbers of customers processed by one cash register 2 per unit time, which is determined by a distribution of a processing time of one cash register 2 in a day and a number of customers processed by one cash register 2 in a day. Predicted waiting customer number Daₜ₊ⱼ at one cash register 2 after predetermined time (j min.) shown in FIG. 4 is calculated by following (Formula 3) using operating unit number n of cash registers 2.

$${D}_{t + j} = max ( 0 , {D}_{t + j - 1} + {R}_{t + j - 1} - P a \cdot n ) \\ {Da}_{t + j} = \frac{{D}_{t + j}}{n} \qquad [ Formula 3 ]$$

Operating unit number determination unit 32f then determines optimum operating unit number N of cash registers 2 after the predetermined time (step S204) and outputs determined optimum operating unit number N from transmitter 34 (step S205). It is thus possible to inform a store manager of store 200 about optimum operating unit number N of cash registers 2.

In determining optimum operating unit number N at step S204, operating unit number determination unit 32f selects, as optimum operating unit number N, operating unit number n with minimum sum value S (penalty) represented by following (Formula 4) using change amount Δn of the operating unit number of cash registers 2.

S=α·Dₜ₊ⱼ+β·C+γ·Δn [Formula 4]

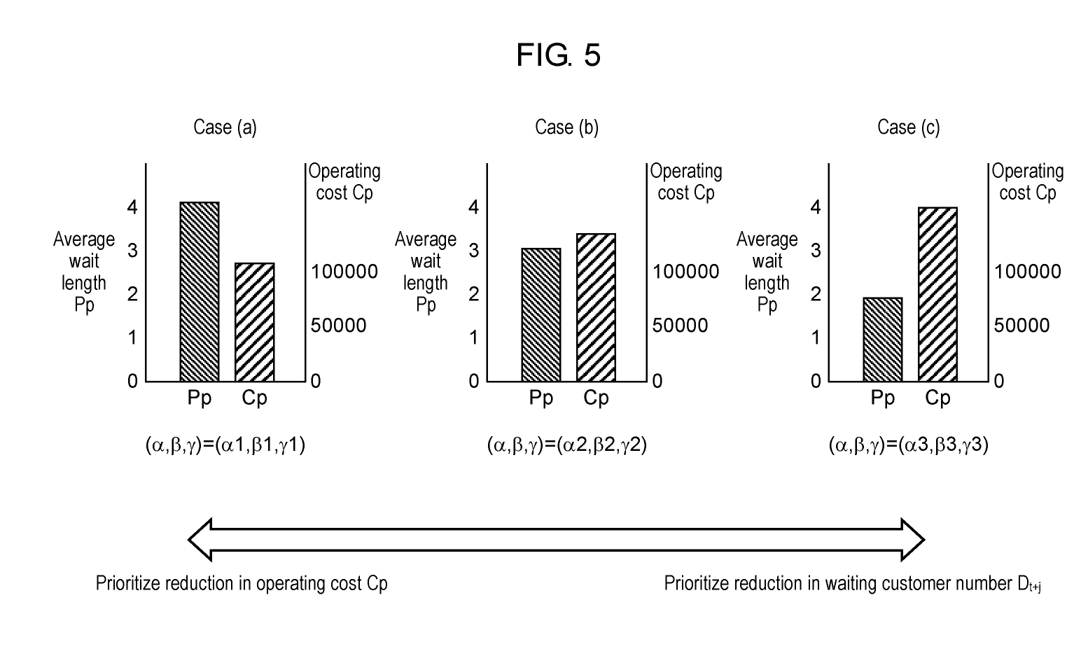

Coefficients α, β, and γ in (Formula 4) are determined in advance by a user of operating unit number determination device 3 (for example, a store manager of store 200) as a result of simulation analysis made in advance based on the past log data. The store manager of store 200 can refer to the simulation result to determine coefficients α, β, and γ according to a balance between an operating cost of cash register 2 and the degree of congestion of cash register 2. FIG. 5 shows a relationship between average wait length Pp, which is an average of numbers of waiting customers indicating the degree of congestion, and operating cost Cp depending on values of coefficients α, β, and γ. Case (a) is a case where a reduction in an operating cost is prioritized over a reduction in a wait length, and α1, β1, and γ1 are used respectively for coefficients α, β, and γ. Case (c) is a case where the reduction in the wait length (waiting customer number Dₜ₊ⱼ) is prioritized over the reduction in the operating cost, and α3, β3, and γ3 are used respectively for coefficients α, β, and γ. Case (b) is a case where a degree of priority of the degree of congestion and the operating cost is intermediate between case (a) and case (c), and α2, β2, and γ2 are used respectively for coefficients α, β, and γ. As shown in FIG. 5, as the degree of congestion is reduced, the operating cost is increased. On the other hand, as the operating cost is reduced, the degree of congestion is increased. The store manager of store 200 can refer to the simulation result to select in advance values of coefficients α, β, and γ according to a balance between the length of a wait for cash register 2 and the operating cost.

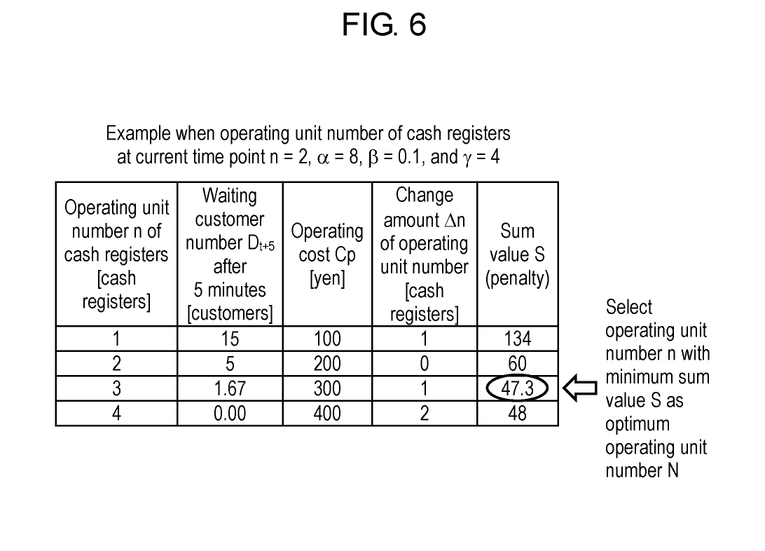

FIG. 6 shows sum value S when two cash registers 2 are operated immediately before the current time point and a store manager sets in advance α=8, β=0.1, and γ=4 for coefficients α, β and γ. In this case, operating unit number determination unit 32f selects, as optimum operating unit number N after the current time point, the operating unit number “3” with minimum sum value S (penalty).

Optimum operating unit number N of cash registers 2 is determined as described above, and it is possible to inform the store manager of store 200 about optimum operating unit number N of cash registers 2. The store manager can thus change actual operating unit number n of cash registers 2 according to informed optimum operating unit number N.

### [3. Effects and Other Benefits]

Operating unit number determination device 3 according to the exemplary embodiment includes store-visitor number measurement unit 32a, waiting customer number measurement unit 32b, influx number prediction unit 32d, processing capability storage unit 33a, operating cost storage unit 33b, congestion degree prediction unit 32e, operating unit number determination unit 32f, and transmitter 34. Store-visitor number measurement unit 32a obtains store-visitor number information indicating store-visitor number Eₜ, which is the number of customers who visited store 200. Waiting customer number measurement unit 32b obtains waiting customer number information indicating waiting customer number Dₜ, which is the number of customers waiting to be processed at cash registers 2. Influx number prediction unit 32d obtains influx number information indicating influx number Rₜ, which is the number of customers who reached cash registers 2 installed in store 200, and calculates influx number Rₜ₊ⱼ, which is the number of customers who will reach cash registers 2 after a predetermined time, based on the store-visitor number information and the influx number information. Processing capability storage unit 33a stores processing capability information indicating processable quantity Pa, which is the processing quantity that can be processed by one cash register 2 per unit time. Operating cost storage unit 33b stores cost information about operating cost C of cash register 2. Congestion degree prediction unit 32e calculates the degree of congestion (predicted waiting customer number Dₜ₋ⱼ), which is the number of customers who are expected to wait to be processed at cash registers 2 after a predetermined time, for each of the operating unit numbers of cash registers 2 based on the obtained waiting customer number information, the predicted influx number Rₜ₊ⱼ calculated, and the stored processing capability information. Operating unit number determination unit 32f calculates optimum operating unit number N of cash registers 2 based on the predicted waiting customer number calculated and the stored cost information. Transmitter 34 outputs operating unit number information indicating calculated optimum operating unit number N.

The system disclosed in PTL 1 does not reflect costs of a check-out operation such as labor costs. In general, as the number of checkouts is increased, the number of waits at the checkouts is reduced, but the costs of the check-out operation are increased.

As described above, operating unit number determination device 3 according to the exemplary embodiment predicts an influx number, which is the number of customers who will reach cash registers 2, based on a state of customers who visited store 200, thus relieving congestion of cash registers 2 while keeping a small operating unit number n of cash registers 2. As the congestion of cash registers 2 is relieved, it is possible to prevent a reduction in customer satisfaction. In addition, as a small operating unit number of cash registers 2 is kept, it is possible to prevent an increase in labor costs, which meets satisfaction of store 200.

Operating unit number determination unit 32f calculates optimum operating unit number N of cash registers 2 based on a difference (Δn) in an operating unit number of cash registers 2 between before and after a change. It is thus possible to prevent frequent variations in operating unit number n.

Processing quantity obtaining unit 32c further obtains processing quantity information indicating processing quantity Pₜ from cash register 2. Influx number prediction unit 32d calculates influx number Rₜ based on the waiting customer number information obtained from waiting customer number measurement unit 32b and the processing quantity information obtained from processing quantity obtaining unit 32c, thus obtaining influx number information. Consequently, if influx number Rₜ cannot be directly measured, influx number Rₜ can be obtained.

Store-visitor number measurement unit 32a measures store-visitor number Eₜ based on images captured by monitoring camera 1a imaging entrance 200A of store 200. Waiting customer number measurement unit 32b measures waiting customer number Dₜ based on images captured by monitoring camera 1b capturing cash registers 2. It is thus possible to calculate predicted influx number Rₜ₊ⱼ based on the measured store-visitor number Eₜ and the measured waiting customer number Dₜ.

Influx number prediction unit 32d adds weight h at the current time point to store-visitor number Eₜ and influx number Rₜ, thus calculating predicted influx number Rᵢ₊ⱼ. It is thus possible to minimize an error between a predicted value and an actually measured value.

Operating unit number determining system 100 according to the exemplary embodiment includes monitoring camera 1a that outputs images obtained by capturing entrance 200A of store 200, a plurality of cash registers 2 installed in store 200, monitoring camera 1b that outputs images obtained by capturing cash registers 2, and operating unit number determination device 3 that uses images obtained from monitoring camera 1a and monitoring camera 1b to calculate optimum operating unit number N of cash registers 2. It is thus possible to relieve congestion of cash registers 2 while keeping a small operating unit number n.

The operating unit number determination method according to the exemplary embodiment determines an operating unit number (optimum operating unit number N) of cash registers 2 by using computer 3C. Computer 3C obtains, at receiver 31, store-visitor number information indicating store-visitor number Eₜ, which is the number of customers who visited store 200, influx number information indicating influx number Rₜ₊ⱼ, which is the number of customers who reached cash registers 2 installed in store 200, and waiting customer number information indicating waiting customer number Dₜ, which is the number of customers waiting to be processed at cash registers 2. Controller 32 calculates predicted influx number Rₜ₊ⱼ, which is the number of customers who are expected to go to cash registers 2 after a predetermined time, based on the obtained store-visitor number information and the obtained influx number information. Controller 32 calculates predicted waiting customer number Dₜ₊ⱼ, which is the number of customers who are expected to wait to be processed at cash registers 2 after a predetermined time, for each of the operating unit numbers of cash registers 2 based on the obtained waiting customer number information, the calculated predicted influx number Rₜ₊ⱼ, and processing capability information indicating processable quantity Pa that can be processed by one cash register 2 per unit time, which is stored in storage unit 33. Controller 32 calculates optimum operating unit number N of cash registers 2 based on predicted waiting customer number Dₜ₊ⱼ calculated and cost information about operating cost C of a cash register stored in the storage unit. This method achieves relief of the congestion of cash registers 2 and keeps a small operating unit number of cash registers 2. It is thus possible to meet both customer satisfaction and satisfaction of store 200.

The program according to the exemplary embodiment causes a computer to perform the operating unit number determination method described above.

As described above, in operating unit number determination device 3, obtaining unit 532 obtains store-visitor number information indicating store-visitor number Eₜ, which is the number of customers who visited store 200, waiting customer number information indicating waiting customer number Dₜ, which is the number of customers waiting to be processed at a plurality of cash registers 2 installed in store 200, and influx number information indicating influx number Rₜ, which is the number of customers added to the customers waiting to be processed at cash registers 2. Influx number prediction unit 32d calculates predicted influx number Rₜ₊ⱼ, which is a number of customers who are expected to go to cash registers 2 and to be added to the customers waiting to be processed at cash registers 2 after predetermined time (j) from current time (t), based on the store-visitor number information and the influx number information. Storage unit 33 stores processing capability information indicating a processable quantity than can be processed by each of cash registers 2 per a certain time and cost information about an operating cost of each of cash registers 2. Congestion degree prediction unit 32e calculates values of predicted waiting customer number Dₜ₊ⱼ, which is the number of customers who are expected to wait to be processed at cash registers 2 after predetermined time (j) from current time point (t), based on the waiting customer number information, predicted influx number Rₜ₊ⱼ, and the processing capability information, with each value corresponding to each of operating unit numbers of n cash registers 2. Operating unit number determination unit 32f calculates an operating unit number (optimum operating unit number N) of cash registers 2 based on predicted waiting customer number Dₜ₋ⱼ and the cost information.

Transmitter 34 may output operating unit number information indicating calculated operating unit number (optimum operating unit number N).

Operating unit number determination unit 32f may calculate operating unit number of cash registers 2 based on predicted waiting customer number Dₜ₋ⱼ, the cost information, and a difference Δn among operating unit numbers of cash registers 2.

Obtaining unit 532 may further obtain processing quantity information indicating processing quantity Pₜ processed by cash registers 2. In this case, influx number prediction unit 32d calculates an influx number based on the waiting customer number information and the processing quantity information to obtain influx number information.

Obtaining unit 532 may measure a store-visitor number based on images of entrance 200A of store 200 and then measure a waiting customer number based on images of cash registers 2.

Influx number prediction unit 32d may add weight W³?h at current time point (t) to the store-visitor number and the influx number, thus calculating predicted influx number Dₜ₋ⱼ.

Operating unit number determining system 100 includes operating unit number determination device 3, first monitoring camera 1a that outputs images obtained by capturing entrance 200A of store 200, a plurality of cash registers 2 including cash registers 2 installed in store 200, and second monitoring camera 1b that outputs images obtained by capturing cash registers 2. Operating unit number determination device 3 uses images obtained from first monitoring camera 1a and second monitoring camera 1b to calculate an operating unit number of cash registers 2 described above among cash registers 2.

An operating unit number (optimum operating unit number N) of cash registers 2 is determined by the following operating unit number determination method. Computer 3C is prepared. Computer 3C stores processing capability information indicating a processable quantity than can be processed by each of cash registers 2 per a certain time and cost information about an operating cost of each of cash registers 2. Computer 3C obtains store-visitor number information indicating store-visitor number Eₜ, which is the number of customers who visited store 200, waiting customer number information indicating waiting customer number Dₜ, which is the number of customers waiting to be processed at cash registers 2 installed in store 200, and influx number information indicating influx number Rₜ, which is the number of customers added to the customers waiting to be processed at cash registers 2. Computer 3C calculates predicted influx number Rₜ₊ⱼ, which is the number of customers who are expected to be added to the customers waiting to be processed at cash registers 2 after predetermined time (j) from current time (t), based on the store-visitor information and the influx number information. Computer 3C calculates values of predicted waiting customer number Dₜ₊ⱼ, which is the number of customers who are expected to wait to be processed at cash registers 2 after predetermined time (j) from current time point (t), based on the waiting customer number information and the processing capability information, with each value corresponding to each of operating unit numbers n of cash registers 2. Computer 3C calculates an operating unit number (optimum operating unit number N) of cash registers 2 based on the cost information about the operating cost of each of cash registers 2 and predicted waiting customer number Dₜ₊ⱼ.

### Other Exemplary Embodiments

The exemplary embodiment has been described above as an illustration of the technique disclosed in the present application. However, the technique in the present disclosure is not limited to the exemplary embodiment, and can also be applied to exemplary embodiments in which changes, replacements, additions, omissions, or the like are made as appropriate. Additionally, constituent elements described in the above exemplary embodiment can be combined to configure a new exemplary embodiment.

The constituent components illustrated in the attached drawings and described in the detailed description may include, for the illustration of the above-described technique, not only constituent components essential for the solution to the problem, but also constituent components not essential for the solution to the problem. Thus, it should not be deemed that, merely based on the fact that the constituent components that are not essential have been illustrated in the attached drawings and described in the detailed description, the constituent components that are not essential are essential.

Further, since the aforementioned exemplary embodiment illustrates the technique of the present disclosure, various changes, replacements, additions, omissions, and the like can be made in the claims and their equivalents.

### INDUSTRIAL APPLICABILITY

The present disclosure is applicable to an operating unit number determination device that predicts a degree of congestion to calculate an operation unit number of cash registers and an operating unit number determining system including the operating unit number determination device.

### REFERENCE MARKS IN THE DRAWINGS

1a monitoring camera

1b monitoring camera

2 cash register

3 operating unit number determination device

11 imaging unit

12 transmitter

21 payment information obtaining unit

22 transmitter

31 receiver

32 controller

32a store-visitor number measurement unit

32b waiting customer number measurement unit

32c processing quantity obtaining unit

32d influx number prediction unit

32e congestion degree prediction unit

32f operating unit number determination unit

33 storage unit

33a processing capability storage unit

33b operating cost storage unit

34 transmitter

100 operating unit number determining system

1. An operating unit number determination device comprising:
an obtaining unit that obtains store-visitor number information indicating a store-visitor number, which is a number of customers who visited a store, waiting customer number information indicating a waiting customer number, which is a number of customers waiting to be processed at a plurality of cash registers installed in the store, and influx number information indicating an influx number, which is a number of customers added to the waiting customer number;
an influx number prediction unit that calculates a predicted influx number, which is a number of customers who are expected to be added to the waiting customer number at the plurality of cash registers after a predetermined time from a current time point, based on the store-visitor number information and the influx number information;
a storage unit that stores processing capability information indicating a processable quantity that can be processed by each of the plurality of cash registers per a certain time and cost information about an operating cost of each of the plurality of cash registers;
a congestion degree prediction unit that calculates a plurality of values of a predicted waiting customer number, which is a number of customers who are expected to wait to be processed at the plurality of cash registers after the predetermined time, based on the waiting customer number information, the predicted influx number, and the processing capability information, where each of the plurality of values corresponds to each of a plurality of operating unit numbers of the plurality of cash registers; and
an operating unit number determination unit that calculates an operating unit number of the plurality of cash registers based on the predicted waiting customer number and the cost information.

2. The operating unit number determination device according to claim 1, further comprising a transmitter that outputs operating unit number information indicating the operating unit number calculated.

3. The operating unit number determination device according to claim 1, wherein the operating unit number determination unit calculates the operating unit number of the plurality of cash registers based on the cost information, a difference among the plurality of operating unit numbers of the plurality of cash registers, and the plurality of values of the predicted waiting customer number.

4. The operating unit number determination device according to claim 1, wherein
the obtaining unit further obtains processing quantity information indicating a processing quantity processed by the plurality of cash registers, and
the influx number prediction unit calculates the influx number based on the waiting customer number information and the processing quantity information to obtain the influx number information.

5. The operating unit number determination device according to claim 1, wherein the obtaining unit measures the store-visitor number based on an image of an entrance of the store and then measures the waiting customer number based on an image of the plurality of cash registers.

6. The operating unit number determination device according to claim 1, wherein the influx number prediction unit adds a weight at the current time point to the store-visitor number and the influx number to calculate the predicted influx number.

7. An operating unit number determining system comprising:
the operating unit number determination device according to claim 1;
a first monitoring camera that outputs an image of an entrance of the store;
the plurality of cash registers installed in the store; and
a second monitoring camera that outputs an image obtained by capturing the plurality of cash registers,
wherein the operating unit number determination device uses the images obtained from the first monitoring camera and the second monitoring camera to calculate the operating unit number of the plurality of cash registers.

8. An operating unit number determining system comprising:
the operating unit number determination device according to claim 6;
a first monitoring camera that outputs the image of an entrance of the store;
the plurality of cash registers installed in the store; and
a second monitoring camera that outputs the image of the plurality of cash registers.

9. An operating unit number determination method for determining an operating unit number of a plurality of cash registers, the operating unit number determination method comprising:
preparing a computer that stores processing capability information indicating a processable quantity that can be processed by each of the plurality of cash registers per a certain time and cost information about an operating cost of each of the plurality of cash registers;
causing the computer to obtain store-visitor number information indicating a store-visitor number, which is a number of customers who visited a store, waiting customer number information indicating a waiting customer number, which is a number of customers waiting to be processed at the plurality of cash registers installed in the store, and influx number information indicating an influx number, which is a number of customers added to the waiting customer number;
causing the computer to calculate a predicted influx number, which is a number of customers who are expected to be added to the waiting customer number at the plurality of cash registers after a predetermined time from a current time point, based on the store-visitor information and the influx number information;
causing the computer to calculate a plurality of values of a predicted waiting customer number, which is a number of customers who are expected to wait to be processed at the plurality of cash registers after the predetermined time, based on the waiting customer number information, the predicted influx number, and the processing capability information, where each of the plurality of values corresponds to each of a plurality of operating unit numbers of the plurality of cash registers; and
causing the computer to calculate an operating unit number of the plurality of cash registers based on the predicted waiting customer number and the cost information.

10. A computer-readable non-transitory recording medium storing a program that causes the computer to perform the operating unit number determination method according to claim 9.
